(19) United States
(12) Patent Application Publication
(10) Pub. No.: US 2026/0167131 A1
(43) Pub. Date: Jun. 18, 2026

(54) MOTOR VEHICLE AND METHOD FOR CONTROLLING THE SAME

(71) Applicant: AUDI AG, Ingolstadt (DE)

(72) Inventor: Alexander Wolz, Lenting (DE)

(73) Assignee: AUDI AG, Ingolstadt (DE)

(21) Appl. No.: 19/420,168

(22) Filed: Dec. 15, 2025

(30) Foreign Application Priority Data
Dec. 16, 2024 (DE) 10 2024 138 074.8

(51) Int. Cl. B60R 16/023; G06F 13/20

(52) U.S. Cl. CPC B60R 16/0231; G06F 13/20; G06F 2213/40

(57) ABSTRACT

A motor vehicle and method for controlling the same where component groups can use different protocols in the motor vehicle, a superordinate software application is connected upstream of the protocol-specific software applications in the motor vehicle and can receive input commands according to a first input protocol and can translate this into different output protocols, so that the protocol-specific software applications can control different control units.

### CROSS REFERENCE TO RELATED APPLICATIONS

This application is a based upon and claims the priority benefit of German Application No. 10 2024 138 074.8 filed on Dec. 16, 2024, the entire contents of which are incorporated by reference herein.

### BACKGROUND

### 1. Field

The invention relates to a motor vehicle and to a method for controlling (actuators and/or sensors of) a motor vehicle.

The invention is based on the situation that the motor vehicle has a central control unit. For actuators and/or sensors, there are a plurality of subordinate control units, wherein two and preferably more subordinate control units are designed to receive control commands according to different protocols.

A multiplicity of units are involved in the assembly of a motor vehicle model at the vehicle manufacturer and also suppliers. This means that some actuators are controlled using a first protocol, other actuators are controlled using a second protocol and so on.

It is then up to the vehicle manufacturer to combine all units.

### 2. Description of the Related Art

US 2024/0 211 229 A1 discloses programming control units of a vehicle. Development is carried out using application programming interfaces, wherein an input protocol for the application programming interface is translated into a uniform protocol for all electronic control units (ECUs) in a vehicle. US 2024/0 171 948 A1 discloses a system for data integration for a computer system of a vehicle having a central system app or API (application programming interface) which is linked to a plurality of other apps.

A general trend is that applications (“apps”) are programmed for motor vehicles and can be loaded by the user into the infotainment system. It becomes difficult if an app is to indirectly access a plurality of subordinate control units. For example, an app that a user wants to use to provide a vehicle interior experience may require access to the lighting, the seat heating, the air conditioning system, and the like. In this case, it becomes difficult if different protocols are used.

### SUMMARY

One object of the invention is to facilitate access to actuators or the control units connected upstream of them (and subordinate to the central control unit).

The object is achieved by the motor vehicle having the features according to Claim 1 and the method having the features according to Claim 9.

The motor vehicle according to an aspect of the invention, which has, as described at the outset, the central control unit and subordinate control units, to which different protocols are assigned, has a central control unit in which a protocol-specific software application is provided for each protocol used for a subordinate control unit. A suitable app is thus stored on the central control unit (hardware). The central control unit now also provides a superordinate application (further software is stored on the hardware and can be run, “central app”) which is designed to receive input commands according to a first input protocol. The superordinate software application is furthermore designed to output first output commands according to a first output protocol for a first protocol-specific software application based on first input commands according to the first input protocol and to output second output commands according to a second output protocol for a second protocol-specific software application based on second input commands according to the first input protocol.

In other words, the superordinate software application has the function of translating the first and second input commands into respective output commands, and this equally in the appropriate protocol.

In this way, an external app (which, as mentioned above, is stored on the infotainment system of the motor vehicle) can be easily programmed, because it only needs to use the first input protocol. However, the app stored on the smartphone does not have to take into account those protocols which are to be used for the subordinate control units. This makes it much easier to program apps.

According to one preferred embodiment of the invention, the superordinate software application is also designed to output third output commands according to a third output protocol for a third protocol-specific software application in response to third input commands and to output fourth output commands according to a fourth output protocol for a fourth protocol-specific software application.

In other words, it becomes possible to control two of the subordinate apps (protocol-specific software application) by means of a single input command (namely the third one in the present case) and thus to ultimately supply a plurality of actuators and/or sensors with control commands. In this case, the superordinate software application has the function of a distributor (a type of “hub”).

Preferably, in this context, there is an overlap with the first and second input commands insofar as the third output protocol for the third software application corresponds to the first output protocol for the first software application. Alternatively or additionally, the fourth output protocol for the fourth software application may correspond to the second output protocol for the second software application.

It may therefore be the case that the third input command controls the same actuators and/or sensors as the first and/or the second input command, wherein the third input command has precisely the peculiarity of being able to control a plurality of actuators and/or sensors at the same time. This also applies to actuator groups and/or sensor groups insofar as they can be controlled by the protocol-specific software application, in particular if they are assigned to a common subordinate control unit.

According to a further preferred embodiment of the invention, the superordinate software application is also designed to transfer further input commands according to a second input protocol into output commands for a protocol-specific software application according to the protocol thereof.

In other words, in this case, there is increased flexibility with regard to external apps (said infotainment system of the motor vehicle) insofar as not only the first but also a second input protocol can be used.

According to a further aspect of the invention, the superordinate software application is designed to also receive, in addition to a first input command according to a first input protocol, a second input command from a further user application according to the first or a second input protocol and to interpret the received input commands and to translate all input commands into consistent commands for at least one subordinate software application.

In this case, “interpreting” involves, for example, the use of a language model (for which the above-mentioned Android® interface definition language interface is suitable). Translating all input commands may involve entirely omitting one aspect in the command from one of the user applications. (The superordinate software application is designed to drop or delete this aspect or to generate an output command which, with respect to at least one input command, implements only some of the aspects contained therein, but otherwise preferably uses all aspects.) Alternatively, if in particular a type of device for providing artificial intelligence or the like (in general: machine learning model) is used, a type of mediation between the commands can take place. (The superordinate software application is designed to generate a single output command from both or all of a plurality of input commands, which output command takes all input commands into account, but preferably implements a compromise and/or preferably carries out an evaluation, optionally with (possibly variable) weighting (determined by the machine learning model itself).)

According to a further preferred embodiment of the invention, in particular with respect to the further aspect with the translation into consistent commands, provision is made for the superordinate software application to be designed to receive an indication of a priority with the input commands and, in the event of a content-related and/or time conflict between the command target of a plurality of incoming input commands, to output output commands in such a way that an input command with a higher priority is considered rather than an input command with a lower priority (priority orchestration). In particular, the superordinate software application is designed to take these priorities into account when translating all input commands into consistent commands.

This means that there may be contradictions, in particular if a plurality of external apps transmit input commands to the central control unit. For example, one app can call up a vehicle interior experience in which the air conditioning ensures cool air, whereas, for example when preparing for a journey by means of another external app, the motor vehicle should already be preheated. In this case, for example, the vehicle interior experience would have to take a back seat. The central control unit thus orchestrates the commands. In addition to complete contradictions in the command targets (where a command target defines the selection of the actuators and/or sensors and at the same time the type of their control), there can also easily be a capacity optimization (for example with regard to the vehicle battery). For example, input commands which communicate by means of an external app that the user is approaching the motor vehicle, for which, for example, the door needs to be opened and/or the lighting needs to be switched on etc., can have priority in the processing over the activation of the infotainment system and the like, which another external app possibly wants to effect.

The superordinate software application can thus be designed, if, in addition to a first input command according to a first input protocol, it also receives a second input command from a further user application according to the first or a second input protocol and interprets the received input commands and translates all input commands into consistent commands for at least one subordinate software application, and in this case (in particular during translation) additionally takes into account measured values from measurement units of the motor vehicle, in particular those measured values which concern physical variables (temperature, pressure, humidity, etc.) or a capacity of functional units of the motor vehicle.

According to a further preferred embodiment of the invention, the superordinate software application provides an interface that uses the Android® interface definition language (AIDL). The superordinate software application is thus an AIDL interface.

According to a further preferred embodiment of the invention, the output protocols include the ASI® and RSI® protocol (from e. Solutions GmbH), the SOME/IP (Scalable Service-Oriented Middleware over IP) protocol and/or the VHAL (Vehicle Hardware Abstraction Layer) protocol. Such protocols are often used in component groups of motor vehicles.

According to a further preferred embodiment of the invention, subordinate control units control at least two of actuator(s) (types), for example, from the group of: lighting device(s), an air conditioning device, actuators relating to a chassis of the motor vehicle, an actuator for selecting driving styles (for example for selecting comfort mode or sport mode), (at least) an actuator for a roof module, (at least) an actuator for a window winder, (at least) an actuator for opening a door (preferably including for the trunk door), actuator(s) for seat massage, (at least one) actuator(s) for seat heating, (at least) an actuator for seat adjustment, (at least) a tire pressure actuator.

The more (more than two, in particular three, four, five, six, seven, eight, or all nine mentioned types of actuators) from said selection are accessible by the invention, the better external apps can access units of the motor vehicle.

The method according to an aspect of the invention for controlling (actuators and/or sensors of) a motor vehicle, in particular a motor vehicle as described above, also comprises according to one preferred embodiment: the motor vehicle receiving a first input command from a user application according to a first input protocol; a superordinate software application of the motor vehicle translating the input command into a command for at least one subordinate software application of the motor vehicle according to a first output protocol; the subordinate software application providing a control command for at least one subordinate control unit of the motor vehicle (using the associated output protocol); the at least one control unit controlling at least one actuator and/or sensor assigned to this control unit.

The method reflects the provision of the superordinate software application in the motor vehicle insofar as an external app (user application) ultimately accesses the motor vehicle.

According to one preferred embodiment of the method according to the invention, the input command is translated into a plurality of commands which are transmitted to different subordinate software applications.

Alternatively or additionally, a subordinate software application transmits at least one control command in each case to different subordinate control units.

In both mentioned cases of a preferred embodiment, provision is therefore made for an input command to ultimately lead to the control of a plurality of actuators and/or sensors by branching (level of the software applications and/or level of the control units). This is especially desirable if a user application (external app) is intended to be used.

According to a further preferred embodiment of the method according to the invention, this comprises: receiving a second input command from a further user application according to a second input protocol; and interpreting the received input commands and translating all input commands into consistent commands for at least one subordinate software application.

In this case, “interpreting” involves, for example, the use of a language model (for which the above-mentioned Android® interface definition language interface is suitable). Translating all input commands may involve entirely omitting one aspect in the command from one of the user applications. Alternatively, if in particular a type of device for providing artificial intelligence or the like is used, a type of mediation between the commands can take place here.

According to one preferred embodiment thereof, provision is made for an indication of a priority to be respectively received with the first and second input commands and for these priorities to be taken into account when translating all input commands into consistent commands.

For applications or application situations which may arise for the method and are not explicitly described here, there can be provision for the method to involve an error message and/or a request to input user feedback being output and/or a default setting and/or a predetermined initial state being set.

One aspect of the invention also includes the control apparatus(es) for the motor vehicle. The control apparatus can comprise a data processing apparatus or a processor device (processor circuit) configured to carry out an embodiment of the method according to the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can each be used as the microprocessor. In addition, the processor device can have program code configured to carry out the embodiment of the method according to the invention when executed by the processor device. The program code may be stored in a data memory of the processor device. The processor device can be based e.g. on at least one circuit board and/or on at least one SoC (system on chip).

The invention also includes developments of the method according to the invention which have features as have already been described in connection with the developments of the motor vehicle according to the invention. For this reason, the corresponding developments of the method according to the invention are not described again here.

The motor vehicle according to the invention is preferably in the form of an automobile, in particular a passenger vehicle or truck, or in the form of a minibus or motorcycle.

As a further solution, the invention may also comprises a computer-readable storage medium comprising program code which, when executed by a computer or a computer network, causes it to carry out an embodiment of the method according to the invention. The storage medium may be provided at least partially as a non-volatile data memory (for example as a flash memory and/or as an SSD—solid state drive) and/or at least partially as a volatile data memory (for example as a RAM—random access memory). The storage medium may be arranged in the computer or computer network. However, the storage medium may also be operated, for example, as what is known as an app store server and/or cloud server on the Internet. The computer or computer network can be used to provide a processor circuit with, for example, at least one microprocessor. The program code may be provided as binary code and/or as assembler code and/or as source code of a programming language (for example Kotlin/Java) and/or as a program script (for example Python). The computer-readable storage medium can alternatively be realized by a signal with computer-readable data, e.g. a time-varying voltage signal and/or a radio signal.

The invention also comprises the combinations of the features of the described embodiments. The invention thus also comprises implementations that each have a combination of the features of several of the described embodiments, unless the embodiments have been described as being mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:
Exemplary embodiments of the invention are described below. In this regard:

FIG. 1 schematically shows the components of a motor vehicle according to one embodiment of the invention and two external apps in which external software applications can be operated; and

FIG. 2 shows a flow diagram for illustrating operations of one embodiment of the method according to the invention.

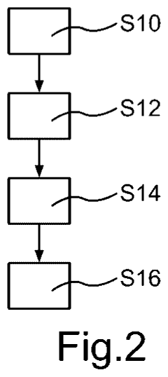

### DETAILED DESCRIPTION

Reference will now be made in detail to the preferred embodiments, examples of which are illustrated in the accompanying drawings, wherein like reference numerals refer to like elements throughout.

The exemplary embodiments explained below are preferred embodiments of the invention. In the exemplary embodiments, the described components of the embodiments each represent individual features of the invention that should be considered independently of one another and that each also develop the invention independently of one another. The disclosure is therefore also intended to comprise combinations of the features of the embodiments other than those illustrated. In addition, the described embodiments can also be supplemented by more of the features of the invention that have already been described.

In the figures, identical reference signs denote functionally identical elements in each case.

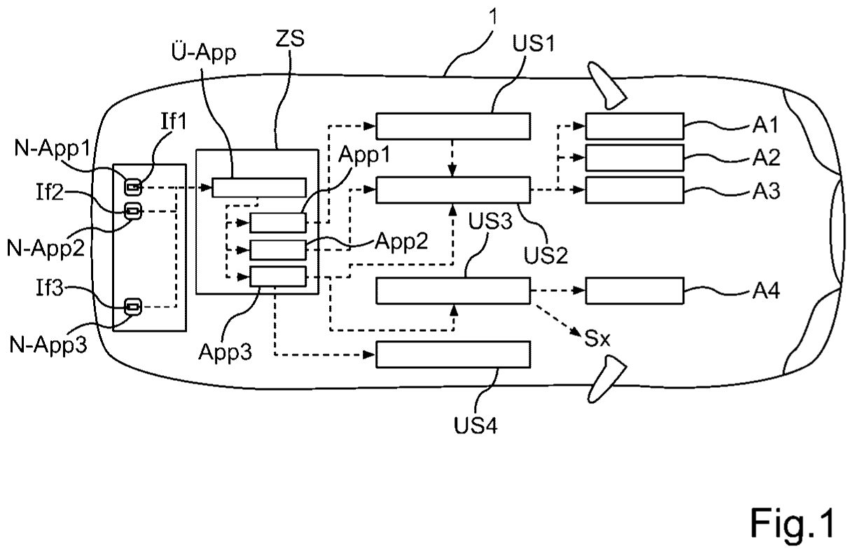

A motor vehicle illustrated in FIG. 1 and denoted there as a whole by 1 comprises a central control unit ZS, downstream of which subordinate control units US1, US2, US3 and US4 are arranged. Whereas the subordinate control unit US1 in turn once again controls the more subordinate control unit US2, the control unit US2 controls the actuators A1, A2 and A3 (for example A1: for ambient light, A2: for the air conditioning, A3: arbitrary). In the exemplary case, the subordinate control unit US3 controls a chassis (actuator group A4), and sensors Sx can also be optionally controlled. The subordinate control unit US4 stands for one or more further subordinate control units which are assigned respective actuators and optionally also sensors, which are not shown here.

The core of the invention is that the central control unit contains a superordinate software application Ü-App, to which protocol-specific software applications App1, App2, App3 are subordinate. In the exemplary case, the protocol-specific software application App1 can use the RSI protocol, the protocol-specific software application App2 can use the SOME/IP protocol, and the protocol-specific software application App3 can use the VHAL protocol. In the present case, the superordinate software application Ü-App is able to translate input commands, which are formulated in a first input protocol, into the respective protocols RSI, SOME/IP and VHAL so that the protocol-specific software applications App1, App2 and App3 then only need to pass on control commands to the subordinate control units assigned to them, which then ultimately use them to control the actuators A1, A2, A3, A4 and also sensors Sx. In the exemplary case in FIG. 1, the RSI protocol is used for the subordinate control unit US1, the SOME/IP protocol is used for the subordinate control unit US2, and the VHAL protocol is used for the subordinate control units US2, US3 and US4.

In the exemplary case, the superordinate software application Ü-App uses the Android® interface definition language, AIDL, that is to say is an AIDL interface.

The user apps N-App1, N-App2 and N-App3 are each assigned AIDL® interfaces IF1, IF2 and IF3. There may therefore be a uniform input protocol (AIDL). This has the advantage that more or less arbitrary apps can be programmed and can then access a combination of actuators A1, A2, A3, A4, and possibly also sensors Sx, without the user apps N-App1, N-App2, N-App3 having to themselves use the protocols (RSI, SOME/IP, VHAL, etc.) specified by the protocol-specific software applications App1, App2, App3.

The method according to the invention according to one embodiment comprises the following operations.

In operation S10, an input command is received from a user application (N-App1, N-App2 or N-App3) according to a first input protocol (AIDL in the present case).

In operation S12, the input command is then translated by the superordinate software application Ü-App in the central control unit into a command for at least one subordinate software application (App2) of the motor vehicle 1 in a first output protocol.

Subsequently, in operation S14, a control command in a first output protocol is provided for at least one subordinate control unit of the motor vehicle (US2 in the present case) by the subordinate software application App2 of the motor vehicle (using the assigned output protocol), and at least one actuator A1, A2, A3 and/or sensor assigned to the at least one control unit US2 is controlled (operation S16) by the latter.

Overall, the examples show how an audi API service can be provided.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A motor vehicle having a central control unit, comprising:
a plurality of subordinate control units for actuators and/or sensors,
wherein at least two subordinate control units, among the plurality of subordinate control units, are designed to receive control commands according to different protocols,
wherein the central control unit provides a protocol-specific software application corresponding to a protocol used for a subordinate control unit,
wherein the central control unit provides a superordinate software application which is designed to:
receive input commands according to a first input protocol,
output first output commands according to a first output protocol for a first protocol-specific software application based on first input commands according to the first input protocol, and
output second output commands according to a second output protocol for a second protocol-specific software application based on second input commands according to the first input protocol.

2. The motor vehicle according to claim 1,
wherein the superordinate software application is designed to output third output commands according to a third output protocol for a third protocol-specific software application based on third input commands and to output fourth output commands according to a fourth output protocol for a fourth protocol-specific software application.

3. The motor vehicle according to claim 2,
wherein the third output protocol for a third software application corresponds to the first output protocol for a first software application and/or the fourth output protocol for a fourth software application corresponds to the second output protocol for a second software application.

4. The motor vehicle according to claim 1,
wherein the superordinate software application is designed to transfer further input commands according to a second input protocol into output commands for a respective protocol-specific software application according to a respective protocol thereof.

5. The motor vehicle according to claim 1,
wherein the superordinate software application is designed to receive an indication of a priority with the input commands and, in an event of a content-related and/or time conflict between a command target of a plurality of incoming input commands, to output output commands in such a way that an input command with a higher priority is considered rather than an input command with a lower priority.

6. The motor vehicle according to claim 2,
wherein the superordinate software application is designed to receive an indication of a priority with the input commands and, in an event of a content-related and/or time conflict between a command target of a plurality of incoming input commands, to output output commands in such a way that an input command with a higher priority is considered rather than an input command with a lower priority.

7. The motor vehicle according to claim 3,
wherein the superordinate software application is designed to receive an indication of a priority with the input commands and, in an event of a content-related and/or time conflict between a command target of a plurality of incoming input commands, to output output commands in such a way that an input command with a higher priority is considered rather than an input command with a lower priority.

8. The motor vehicle according to claim 1,
wherein the superordinate software application provides an interface that uses the Android® interface definition language.

9. The motor vehicle according to claim 1,
wherein output protocols include the ASI and RSI protocol, the SOME/IP protocol, and/or the VHAL protocol.

10. The motor vehicle according to claim 1,
wherein the plurality of subordinate control units control at least two actuators from among the following:
a lighting device,
an air conditioning device,
an actuator relating to a chassis of the motor vehicle,
an actuator for selecting driving styles,
an actuator for a roof module,
an actuator for a window winder,
an actuator for opening a door,
an actuator for seat massage,
an actuator for seat heating,
an actuator for seat adjustment,
a tire pressure actuator.

11. A method of controlling a motor vehicle, comprising:
receiving, by the motor vehicle, a first input command from a user application according to a first input protocol;
translating, by a superordinate software application of the motor vehicle, an input command into a command for at least one subordinate software application of the motor vehicle in a first output protocol;
providing, by the at least one subordinate software application, a control command for at least one subordinate control unit of the motor vehicle;
controlling, by at least one control unit, at least one actuator and/or sensor assigned to the at least one control unit.

12. The method according to claim 11,
wherein the first input command is translated into a plurality of commands that are transmitted to different subordinate software applications.

13. The method according to claim 11,
wherein a subordinate software application transmits at least one control command in each case to different subordinate control units.

14. The method according to claim 11, comprising:
receiving a second input command from a further user application according to the first input protocol or a second input protocol; and
interpreting received input commands and translating all input commands into consistent commands for at least one subordinate software application.

15. The method according to claim 14,
wherein an indication of a priority is respectively received with the first input command and second input command and priorities are taken into account when translating all input commands.
